(19) United States
(12) Patent Application Publication
(10) Pub. No.: US 2024/0177191 A1
(43) Pub. Date: May 30, 2024

(54) Cross-Platform Resource Optimization

(71) Applicant: Oracle International Corporation, Redwood Shores, CA (US)

(72) Inventors: Jason Canney, Highlands Ranch, CO (US); Richard Martin Berger, Boulder, CO (US); Megan Margraff, Trumbull, CT (US); Frank Appiah, Greenwood Village, CO (US); Hilary Joy Traut, Boulder, CO (US); Andrew John Grabowski, Northglenn, CO (US)

(73) Assignee: Oracle International Corporation, Redwood Shores, CA (US)

(21) Appl. No.: 18/433,050

(22) Filed: Feb. 5, 2024

Related U.S. Application Data
(63) Continuation of application No. 17/903,895, filed on Sep. 6, 2022.
(60) Provisional application No. 63/344,870, filed on May 23, 2022.

(51) Int. Cl. G06Q 30/0242; G06Q 30/0204

(52) U.S. Cl. CPC G06Q 30/0243; G06Q 30/0204; G06Q 30/0244

(57) ABSTRACT

Techniques for determining recommended allocations of resources among different platforms that sell a common type of inventory. Determining the allocations can include obtaining parameters of a campaign from a client. Determining the allocations can include combining current campaign parameters and scoring with historical campaign performance data to create recommendations for dividing resources among different media platforms.

### BENEFIT CLAIMS; RELATED APPLICATIONS; INCORPORATION BY REFERENCE

Each of the following applications are hereby incorporated by reference: application Ser. No. 17/903,895, filed Sep. 6, 2022; Application No. 63/344,870, filed May 23, 2022. The Applicant hereby rescinds any disclaimer of claim scope in the parent application(s) or the prosecution history thereof and advises the USPTO that the claims in this application may be broader than any claim in the parent application(s).

### TECHNICAL FIELD

The present disclosure relates to computer-implemented techniques for cross-platform resource consumption. In particular, the present disclosure relates to allocating resources for improving performance.

### BACKGROUND

The advertising industry purchases advertising inventory for promotional campaigns from media platforms and measures performance of the promotional campaigns to determine the campaigns' effectiveness. The media platforms can include traditional televisions services (e.g., linear television services), connected television services (e.g., streaming television services), and digital streaming services (e.g., on-demand Internet services). Traditional television services sell advertising inventory based on Cost per Thousand Impressions (CPM) and evaluate performance based on Gross Rating Points (GRP). Digital streaming services sell inventory programmatically on-demand. Effectiveness of digital advertisements are calculated by cost per click (CPC) and cost per acquisition (CPA). Using such metrics, advertisers can estimate returns on their investments in promotional campaigns.

### SUMMARY

One or more embodiments recommend allocations of resources among different platforms. In a non-limiting example, a system determines recommended resource allocations of budgets that maximize effectiveness of a promotional campaign implemented on multiple media platforms, including linear television, connected, and digital streaming. The system can obtain parameters of the promotional campaign from a client and combines campaign parameters with historical data to compute recommendations and rankings of resource divisions among different platforms.

One or more embodiments uses a trained machine learning model to recommend resource allocations. The system obtains parameters of a promotional campaign from a user interface tool. The parameters include data points associated with a target demographic of a platform based on impressions across different information platforms. The data points may include: budgets used for the different platforms, impressions obtained for the different platforms based on the corresponding budgets, weights for impressions of the different platforms based on demographics, and an expected return on investment (ROI). Additionally, using the machine learning model, the system determines weighted values for the individual data points and computes effectiveness values for the individual data points based on weighted values of the individual data points. Further, using the machine learning model, the system generates a polynomial function based on the set of data points and the effectiveness values. The system recommends resource allocations based on a data point associated with a maximum effectiveness for the polynomial function.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 shows a system block diagram illustrating an example of an environment for implementing systems and processes in accordance with one or more embodiments.

FIG. 2 shows a system block diagram illustrating an example of a resource planning system in accordance with one or more embodiments.

FIG. 3 shows a functional flow block diagram illustrating example operations for resource planning in accordance with one or more embodiments.

FIG. 4 shows a functional flow block diagram illustrating example operations for resource distribution modelling in accordance with one or more embodiments.

FIG. 5 shows a functional flow block diagram illustrating example operations for training a resource distribution model in accordance with one or more embodiments.

FIG. 6 shows a block diagram that illustrates a computer system in accordance with one or more embodiments.

### DETAILED DESCRIPTION

In the following description, for the purposes of explanation, numerous specific details are set forth in order to provide a thorough understanding. One or more embodiments may be practiced without these specific details. Features described in one embodiment may be combined with features described in a different embodiment. In some examples, well-known structures and devices are described with reference to a block diagram form in order to avoid unnecessarily obscuring the present invention.

Systems, methods, and computer program products consistent with one or more embodiments determine recommended allocations of resources among different platforms. An example system obtains data points associated with a target demographic of a promotional campaign based on historical platform impressions generated across a plurality of media platforms. Individual data points can include a first portion of a particular resource used for generating impressions on the individual platforms. The system also determines weighted values for the individual data points. Determining the weighted values can include applying weights for the media platforms to a number of impressions to generate corresponding weighted values. The system further computes effectiveness values for the individual data points based the weighted values of the individual data points. Additionally, the system generates a polynomial function based on the set of data points and the effectiveness values. The system determines a maximum effectiveness value for the polynomial function. The system determines a first data point of the set of data points associated with the maximum effectiveness for the polynomial function. The system communicates recommended divisions of the resource for allocation among the plurality of information platforms based on the first data point associated with the maximum effectiveness for the polynomial function.

Reference will now be made in detail to specific implementations illustrated in the accompanying drawings and figures. In the following detailed description, numerous specific details are set forth to provide a thorough understanding of the invention. However, it will be apparent to one of ordinary skill in the art that implementations may be practiced without these specific details. In other instances, well-known methods, procedures, components, circuits, and networks have not been described in detail so as not to unnecessarily obscure aspects of the implementations.

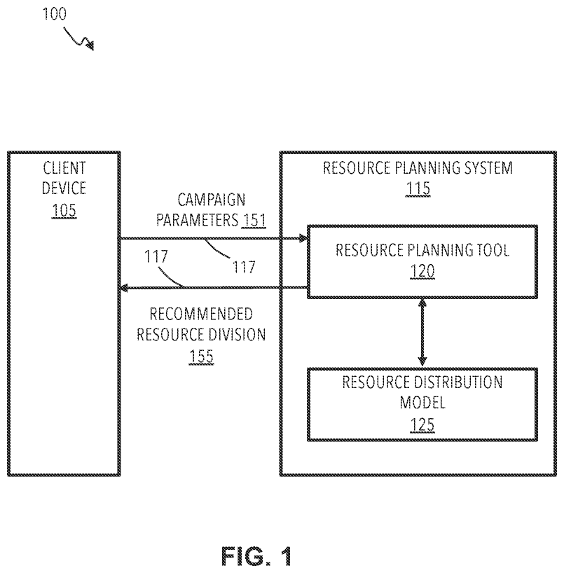

FIG. 1 shows a block diagram illustrating an example of an environment 100 for implementing systems, methods, and computer program products in accordance with one or more embodiments consistent with the present disclosure. The environment 100 can include a client device 105 communicatively linked to a resource planning system 115 via one or more communication channels 117. The resource planning system 115 can be a computing system of a Software as a Service (SaaS) provider and the client device 105 can be a computing device of a tenant of the Software as a Service. The client device 105 can be a personal computer, a tablet computer, a computing terminal or the like. The communication channels 117 can be a peer-to-peer network, a local area network, a wide area network, the Internet, or a combination thereof. The client device 105 may be local to and/or remote from a computer network. The client device 105 communicates requests to the resource planning system 115 using a communications protocol, such as Hypertext Transfer Protocol (HTTP). A user of the client device 105 can communicate through an interface, such as a client interface (such as a web browser), a program interface, or an application programming interface (API).

The resource planning system 115 can include a resource planning tool 120 and a resource distribution model 125. As detailed below, the resource planning tool 120 can generate a user interface for the client device 105 for communicating information that define a promotional campaign. For example, the resource planning tool 120 can receive parameters of the promotional campaign from the user via the client device 105 and communication channels 117. The parameters can include, for example, product type, target demographic, target media platforms, and resource constraints (e.g., budget). Additionally, the resource planning tool 120 can receive recommendations from the resource distribution model 125 and modify the parameters of the promotional campaign. For example, the resource planning tool 120 can obtain recommendations to provide future campaigns with best practices for campaign structure for similar campaigns.

The resource distribution model 125 receives the parameters from the resource planning tool 120 and determines an allocation of resources among the media platforms predicted to maximize an effectiveness (e.g., ROI) of the promotional campaign. The recommended allocation of resources can be transmitted to the resource planning tool 120 for communication to the client device 105. The resource planning system 115 can also allow the user to modify the parameters obtained by the resource planning tool 120 to obtain multiple recommendations for comparison.

In one or more embodiments, the environment 100 may include more or fewer components than the components illustrated in FIG. 1. For example, in some embodiments can include multiple client devices 105 associated with one or more users or tenants. The components illustrated in FIG. 1 may be local to or remote from each other. The components illustrated in FIG. 1 may be implemented in software and/or hardware. Each component may be distributed over multiple applications and machines. Multiple components may be combined into one application and/or machine. Operations described with respect to one component may instead be performed by another component.

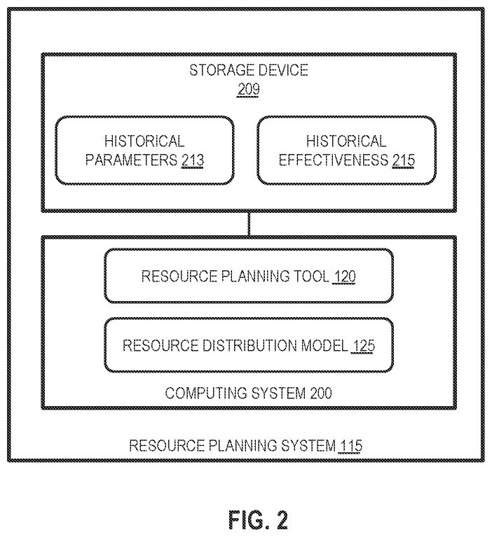

FIG. 2 shows a system block diagram illustrating an example of a resource planning system 115, which can be the same or similar to that described above. As illustrated in FIG. 2, the resource planning system 115 includes hardware and software that perform processes and functions disclosed herein. In some embodiments, the resource planning system 115 includes a computing device 205 and storage systems 209. For example, the computing system 200 can be one or more mainframes, servers, personal computers, or other suitable computing devices. It is understood the computing system 200 is only representative of various possible computing devices that can perform the processes described herein. To this extent, in embodiments, the functionality of the computing system 200 can be any combination of general and/or specific purpose hardware and/or computer program instructions. In each embodiment, the program instructions and hardware can be created using standard programming and engineering techniques.

The storage system 209 can be a computer-readable, non-volatile hardware storage device that stores information and program instructions. For example, the storage system 209 can be one or more flash drives, hard disk drives, or other suitable storage devices. In one or more embodiments, storage system 209 is any type of storage unit and/or device (e.g., a file system, database, collection of tables, or any other storage mechanism) for storing data. Further, the storage system 209 may include multiple different storage units and/or devices. The different storage units and/or devices may or may not be of the same type or located at the same physical site. One or more embodiments store historical parameters 213 of promotional campaigns in the storage system 209. The historical parameters 213 can include information of prior budgets, demographics, weights, allocations, returns on investments, and the like. One or more embodiments also store historical effectiveness 215 of prior promotional campaigns. The historical effectiveness 215 can be a rating or ranking of the promotional campaigns' effectiveness based on impressions and return on invested budget. The historical parameters 213 and historical effectiveness 215 can be indexed and stored in one or more searchable databases.

The computing system 200 executes computer program instructions, such as an operating system and/or application programs, which can be stored in a memory device and/or the storage system 209. The computing system 200 can also execute computer program instructions for the resource planning tool 120 and the resource distribution model 125. The resource planning tool 120 and the resource distribution model 125 can be program instructions, hardware, or a combination thereof. As described above, the resource planning tool 120 can generate a user interface through which a user (e.g., user of client device 105) can create and modify a promotional campaign by communicating parameters of the campaign. Additionally, the resource planning tool 120 can interact with the resource distribution model 125 to communicate the parameters of the promotional campaign for processing and receive recommended resource allocations for communication to a user. The resource distribution model 125 can receive the parameters from the resource planning tool 120 and determine an allocation of resources among the media platforms predicted to maximize an effectiveness (e.g., ROI) of the promotional campaign. One or more embodiments generate the resource distribution model 125 by training a machine learning model trained using a machine learning algorithm.

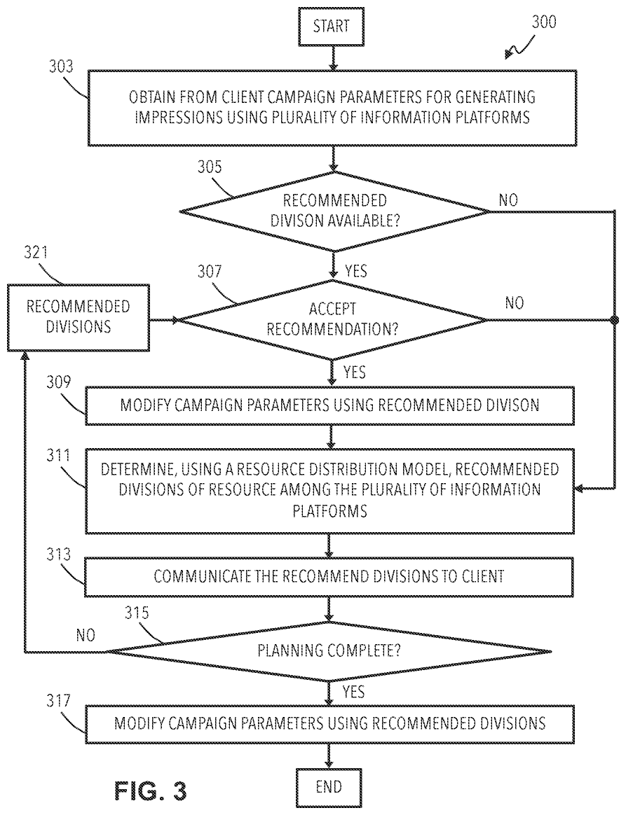

The flow diagrams in FIGS. 3, 4, and 5 illustrate examples of the functionality and operation of possible embodiments of systems, methods, and computer program products consistent with the present disclosure. Each block in the flow diagrams of FIGS. 3, 4, and 5 can represent a module, segment, or portion of program instructions, which includes one or more computer executable instructions for implementing the illustrated functions and operations. In some alternative embodiments, the functions and/or operations illustrated in a particular block of the flow diagram can occur out of the order shown in FIGS. 3, 4, and 5. For example, two blocks shown in succession can be executed substantially concurrently, or the blocks can sometimes be executed in the reverse order, depending upon the functionality involved. It will also be noted that each block of the flow diagram and combinations of blocks in the block can be implemented by special purpose hardware-based systems that perform the specified functions or acts, or combinations of special purpose hardware and computer instructions.

FIG. 3 shows a functional flow block diagram illustrating example process 300 for resource planning in accordance with one or more embodiments. At block 303, a system (e.g., resource planning system 115) obtains promotional campaign parameters for generating impressions using more than one platform. One or more embodiments obtain the parameters from a client device (e.g., client device 105). For example, the system can provide a user interface (e.g., a graphic user interface) to the client device that receives information from a user, or the system can receive a data file from including the parameters. In some implementations, the user interface prompts the user to select parameters from one or more libraries of historical parameters (e.g., historical parameters 213). The parameters can include, for example, a product segment (e.g., Auto, Home Improvement, etc.), a target demographic (e.g., all people 22 to 35 years-old), and an advertising split among multiple types of media platforms (e.g., digital video 30%, connected television 50%, linear television 20%). Additionally, the system can obtain predicted impression performance, including total impressions per platform and a weight of the impressions. For example, the expected total impressions for digital video, cable television, and linear television can be 20,000, 1,000, and 100, respectively. The weighting can represent an expected outcome per platform. For example, weights associated with digital video, cable television, and linear television can be 3, 3, and 1, respectively, wherein a weight of 3 indicates a high outcome, a weight of 2 indicates a medium outcome, and weight of 1 indicates an informational outcome. Further, the system can obtain an expected return on investment (e.g., 2%) for the given allocation, total impressions, and impression weights.

At block 305, the system determines whether a preexisting recommended resource division is available for the campaign. For example, the system can select a preexisting recommendation based on past promotional campaigns having same or similar parameters to those obtained at block 303. In some implementations, the user interface prompts the user to select parameters from one or more libraries of historical divisions (e.g., historical parameters 213).

If there are not preexisting recommended resource division available (e.g., block 305 is “No”), then the process 300 proceeds to block 311, as described below. On the other hand, if the recommendation is available (block 305 is “Yes”), then at block 307, the system determines whether the recommendation of block 305 was accepted. If not (e.g., block 305 is “No”), then the process 300 proceeds to block 311, as described below. If the recommendation was accepted, (e.g., block 307 is “Yes”), then at block 309, the system modifies the campaign parameters with parameters included in the recommendation of block 305.

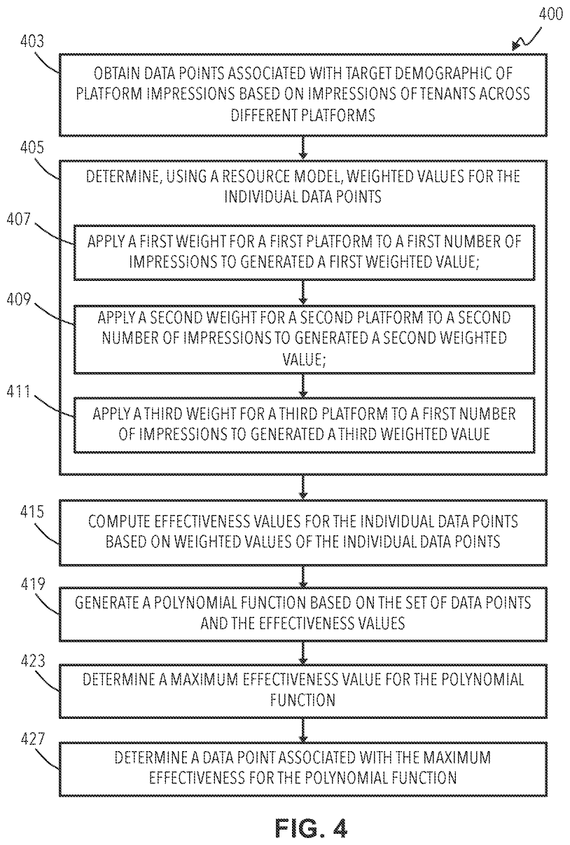

At block 311, the system (e.g., using resource distribution model 125) determines recommended divisions of resource among the plurality of information platforms for the parameters obtained at block 303. One or more embodiments determine the recommendations as described below with reference to FIG. 4. For example, the recommendation can be based on a predicted ROI resulting from budget divisions included in the parameters. The recommendation can include a predicted ranking among a predetermined range of potential ROI rankings. For example, based on the parameters obtained at block 303, the system can indicate whether the ROI is one of a set of predefined categories, such as: unfavorable, favorable, and exceptional. Additionally, the system can score the return a promotional campaign using, for example, a scale 1 to 10, wherein 1 is poor and 10 is exceptional. At block 313, the system communicates the recommended divisions, ROI level, and ROI score to the client via the user interface.

At block 315, the system determines whether the promotional campaign planning is complete. For example, the user may iteratively calculate and refine the resource divisions for comparison based on recommendations determined by the system to determine one or more divisions providing the best ROI. Upon completion of the comparisons and selection of a division of resources, the user can indicate the completion to the user interface. If planning is complete (e.g., block 315 is “Yes”), then at block 317 the system modifies the campaign parameters based on the divisions recommend at block 313 and the process 300 ends. On the other hand, if the planning is not complete (e.g., block 315 is “No”), then the process can, recommend divisions at block 321 and return to block 307.

FIG. 4 shows a functional flow block diagram illustrating example operations for resource distribution modelling in accordance with one or more embodiments. At block 403, a system (e.g., resource planning system 115) obtains parameters from a user interface tool (e.g., resource planning tool 120). The parameters can be data points associated with impressions of a target demographic on a particular media platform based on impressions across different media platforms. As described above, the parameters can include: a budget portion used for digital media, a budget portion used for connected television, a budget portion used for linear television, impressions obtained for digital media based on the corresponding budget, impressions obtained for connected television based on the corresponding budget, impressions obtained for linear television based on the corresponding budget, a weight for digital impressions based on the demographics, a weight for connected television impressions based on the demographics, and a weight for linear impressions based on that demographics, and an expected ROI.

At block 405, the system determines weighted values for the individual data points. Determining the weight values at block 405 can include, applying a first weight for a first platform to a first number of impressions to generate a first weighted value at block 407, applying a second weight for a second platform to a second number of impressions to generate a second weighted value at block 409; and applying a third weight for a third platform to a first number of impressions to generate a third weighted value at block 411. For example, digital video can be weighted 30%, connected television can be weighted 50%, and linear television can be weighed 20%.

At block 415, the system computes effectiveness values for the individual data points based on weighted values of the individual data points. The effectiveness values can represent actual impressions based on media sales. The weighted values can be assigned based on percentages of total sales. For example, a weight of 3 indicates a high percentage, a weight of 2 indicates a medium percentage, and weight of 1 indicates low percentage. At block 419, the system generates a polynomial function based on the set of data points and the effectiveness values. At block 423, the system determines a maximum effectiveness value for the polynomial function. At block 427, the system determines a data point associated with the maximum effectiveness for the polynomial function.

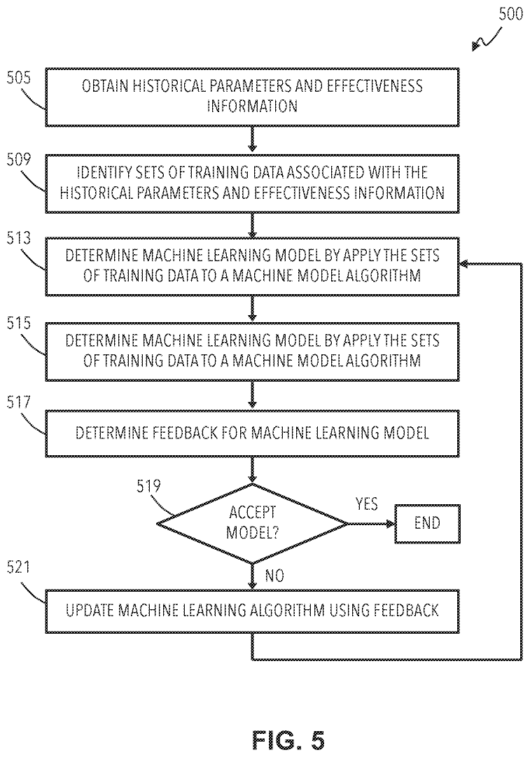

Blocks 415, 419, 423, and 427 can be performed by a machine learning model that maps the polynomial function to the data points and determines a maximum ROI. For example, as described regarding FIG. 5 below, the historical parameters and historical effectiveness information (e.g., historical parameters 213 and historical effectiveness 215) can be used as training data for the machine learning model, the system can iteratively determine weights of a polynomial function. The system can determine a set of historical data points corresponding to individual sets of demographics (e.g., adult females between 18 and 25). The system can use the data points to build polynomial functions corresponding to the individual demographic groups that computes ROI as a function of 9-dimensions.

FIG. 5 shows a functional flow block diagram illustrating example operations for training a resource distribution model in accordance with one or more embodiments. At block 505, a system (e.g., resource planning system 115) obtains historical parameters and historical effectiveness information (e.g., historical parameters 213 and historical effectiveness 215). As previously described, the historical parameters can be parameters of previous promotional campaigns, such as information of prior budgets, demographics, weights, allocations, returns on investments, and the like. The historical effectiveness information can be a rating or ranking of the promotional campaigns' effectiveness based on impressions and return on invested budget.

At block 509, the system may then identify training sets for a machine learning model from the historical parameters. For example, the training set may be associated with the budget resources allocated by previous promotional campaigns to particular media platforms for generating impressions on the platforms. In some implementations, the data points of the training sets include campaign identifiers, product segments/contexts, product types, target demographics, portions of the budget used in generating platform impressions on the respective media platforms, and actual quantities of impressions generated on the respective platforms based on the portion of the resource allocated to the platforms.

At block 513, the system determines a machine learning model by applying the sets of training data identified at block 509 to a machine learning algorithm. The machine learning model analyzes the training data set to identify data and patterns of effectiveness of the budget resource allocations at particular media platforms in generating impressions on the platforms. For example, the machine learning model can be a random forest model. Other machine learning models applied can include, but are not limited to linear regression, logistic regression, linear discriminant analysis, classification and regression trees, naïve Bayes, k-nearest neighbors, learning vector quantization, support vector machine, bagging and random forest, boosting, backpropagation, and/or clustering. Alternatively, the system can use Poisson model descriptive analysis.

At block 515, the system applies the machine learning model determined at block 515 on historical information (e.g., historical parameters 213) to predict effectiveness of the budget resource allocations at particular media platforms in generating impressions (e.g., ROI). At block 517, the system obtains feedback on the machine learning model applied at block 513. For example, the feedback may score the predicted effectiveness (e.g., ROI) of the budget resource allocations across particular media platforms in generating impressions in comparison to the historical effectiveness information.

At block 519, the system can determine whether to accept the machine learning model based on the feedback determined at block 517. The determination can be based on whether the score of the predicted effectiveness exceeds a predetermined threshold. For example, the score of the machine learning model's predicted effectiveness score can be in a range of 0 to 100 and the predetermined threshold can be a score of 80. Accordingly, if the machine learning model's predicted effectiveness score is greater than or equal to 80, the system may determine accept the model. If the score is less than 80, the system may continue the process.

If the system determines to accept the machine learning model (e.g., block 519 is “Yes”), then the process 500 can end. On the other hand, if the system determines not accept the machine learning model (e.g., block 519 is “No”), then at block 521, the machine learning algorithm and/or the training set may be updated, thereby improving the machine learning model's analytical accuracy. Once updated at block 521, the system may iteratively return to block 513 to further train the machine learning model by applying additional training sets.

Once updated at block 521, the system may iteratively return to block 513 to further train the machine learning model, or one or more machine learning models of the same or different types (e.g., random forest and Poisson model descriptive analysis), by applying additional training sets to identify a m

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

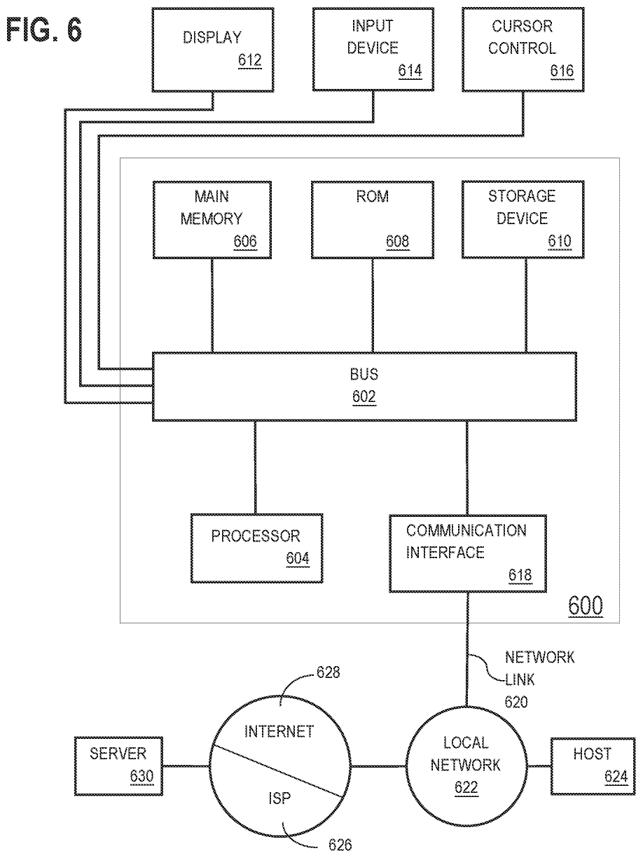

FIG. 6 shows a block diagram that illustrates an example computer system 600 in accordance with one or more embodiments. Computer system 600 can be the same or similar to the computing system previously described herein (e.g., computing system 200). Computer system 600 includes a bus 602 or other communication mechanism for communicating information, and a hardware processor 604 coupled with bus 602 for processing information. Hardware processor 604 may be, for example, a general-purpose microprocessor.

Computer system 600 also includes a main memory 606, such as a random-access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk or optical disk, is used and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 610, which can be the same or similar to the storage device previously described herein (e.g., storage system 209). Volatile media includes dynamic memory, such as main memory 606. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid-state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 uses a two-way data communication coupling to a network link 620 that is connected to a local network 622. For example, communication interface 618 may be an integrated services digital network (ISDN) card, cable modem, satellite modem, or a modem to connect to a corresponding type of telephone line. As another example, communication interface 618 may be a local area network (LAN) card to connect to a compatible LAN. Wireless links may also be implemented. In any such embodiment, communication interface 618 sends and receives electrical, electromagnetic, or optical signals that carry digital data streams representing various types of information.

Network link 620 typically communicates through one or more networks to other data devices. For example, network link 620 may connect through local network 622 to a host computer 624 or to data equipment operated by an Internet Service Provider (ISP) 626. ISP 626 in turn communicates services through the worldwide packet data communication network now commonly referred to as the “Internet” 628. Local network 622 and Internet 628 both use electrical, electromagnetic, or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618. The received code may be executed by processor 604 as it is received, and/or stored in storage device 610, or other non-volatile storage for later execution.

Any combination of the features and functionalities described herein may be used in accordance with one or more embodiments. In the foregoing specification, embodiments have been described with reference to numerous specific details that may vary from embodiment to embodiment. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A non-transitory computer readable medium comprising instructions which, when executed by one or more hardware processors, causes performance of operations comprising:
obtaining a set of historical data points, associated with a target demographic for a plurality of advertising campaigns, based on historical platform impressions generated for a plurality of tenants across a plurality of media platforms, individual data points of the set of data points comprising:
a first portion of a particular resource used for generating platform impressions on a first media platform of the plurality of media platforms;
a first quantity of impressions generated on the first media platform based on the first portion of the particular resource;
a second portion of the particular resource used for generating impressions on a second media platform of the plurality of media platforms; and
a second quantity of impressions generated on the second media platform based on the second portion of the particular resource;
determining historical weighted values of the set of historical data points, wherein determining the weighted values comprises:
applying a first weight for the first media platform to the first quantity of impressions to generate a first weighted value;
applying a second weight for the second media platform to the second quantity of impressions to generate a second weighted value;
obtaining historical effectiveness information corresponding to the plurality of advertising campaigns;
identifying a plurality of sets of training data points using the historical weighted values of the set of the set of historical data points and historical effectiveness information;
training a machine leaning model based on the plurality of sets of training data points to compute effectiveness values for advertising campaigns;
obtaining a candidate set of data points corresponding to a plurality of candidate advertising campaigns;
computing a particular set of weighted values based on the candidate set of data points;
computing, by the machine leaning model, effectiveness values for the individual data points of the candidate set of data points based on the particular set of weighted values;
determining a maximum of the effectiveness values;
selecting a target data point of the candidate set of data points associated with the maximum of the effectiveness values;
communicating recommended divisions of a second resource for allocation among the plurality of media platforms based on the target data point associated with the maximum of the effectiveness values; and
updating the machine learning model based on feedback corresponding to the effectiveness values computed for at least one of the target set of data points.

2. The computer readable medium of claim 1, wherein training the machine leaning model comprises identifying data and patterns of effectiveness of particular resource allocations at particular media platforms of the plurality of media platforms in generating platform impressions.

3. The computer readable medium of claim 2, wherein the machine learning model is a random forest model.

4. The computer readable medium of claim 2, wherein the sets of training data points include product segments, product types, target demographics, portions of a budget used in generating platform impressions, and actual quantities of platform impressions.

5. The computer readable medium of claim 1, wherein the plurality of media platforms comprise one or more of types of media platforms, including: linear television services, connected television services, and streaming digital video services.

6. The computer readable medium of claim 1, wherein the resources comprise a budget.

7. The computer readable medium of claim 6, wherein effectiveness values represent Returns-on-Investment of the budget.

8. The computer readable medium of claim 7, wherein communicating recommend divisions comprises identifying percentages of the budget for allocation to the plurality of media platforms based on a first data point associated with the maximum of the effectiveness values.

9. A method comprising:
obtaining a set of historical data points, associated with a target demographic for a plurality of advertising campaigns, based on historical platform impressions generated for a plurality of tenants across a plurality of media platforms, individual data points of the set of data points comprising:
a first portion of a particular resource used for generating platform impressions on a first media platform of the plurality of media platforms;
a first quantity of impressions generated on the first media platform based on the first portion of the particular resource;
a second portion of the particular resource used for generating impressions on a second media platform of the plurality of media platforms; and
a second quantity of impressions generated on the second media platform based on the second portion of the particular resource;
determining historical weighted values of the set of historical data points, wherein determining the weighted values comprises:
applying a first weight for the first media platform to the first quantity of impressions to generate a first weighted value;
applying a second weight for the second media platform to the second quantity of impressions to generate a second weighted value;
obtaining historical effectiveness information corresponding to the plurality of advertising campaigns;
identifying a plurality of sets of training data points using the historical weighted values of the set of the set of historical data points and historical effectiveness information;
training a machine leaning model based on the plurality of sets of training data points to compute effectiveness values for advertising campaigns;
obtaining a candidate set of data points corresponding to a plurality of candidate advertising campaigns;
computing a particular set of weighted values based on the candidate set of data points;
computing, by the machine leaning model, effectiveness values for the individual data points of the candidate set of data points based on the particular set of weighted values;
determining a maximum of the effectiveness values;
selecting a target data point of the candidate set of data points associated with the maximum of the effectiveness values;
communicating recommended divisions of a second resource for allocation among the plurality of media platforms based on the target data point associated with the maximum of the effectiveness values; and
updating the machine learning model based on feedback corresponding to the effectiveness values computed for at least one of the target set of data points.

10. The method of claim 9, wherein training the machine leaning model comprises identifying data and patterns of effectiveness of particular resource allocations at particular media platforms of the plurality of media platforms in generating platform impressions.

11. The method of claim 10, wherein the machine learning model is a random forest model.

12. The method of claim 10, wherein the sets of training data points include product segments, product types, target demographics, portions of a budget used in generating platform impressions, and actual quantities of platform impressions.

13. The method of claim 9, wherein the plurality of media platforms comprise one or more of types of media platforms, including: linear television services, connected television services, and streaming digital video services.

14. The method of claim 9, wherein the resources comprise a budget.

15. The method of claim 14, wherein effectiveness values represent Returns-On-Investment of the budget.

16. The method of claim 15, wherein communicating recommend divisions comprises identifying percentages of the budget for allocation to the plurality of media platforms based on a first data point associated with the maximum of the effectiveness values.

17. A system comprising a processor and a computer-readable data storage device storing program instructions that, when executed by the processor, control the system to perform operations comprising:
obtaining a set of historical data points, associated with a target demographic for a plurality of advertising campaigns, based on historical platform impressions generated for a plurality of tenants across a plurality of media platforms, individual data points of the set of data points comprising:
a first portion of a particular resource used for generating platform impressions on a first media platform of the plurality of media platforms;
a first quantity of impressions generated on the first media platform based on the first portion of the particular resource;
a second portion of the particular resource used for generating impressions on a second media platform of the plurality of media platforms; and
a second quantity of impressions generated on the second media platform based on the second portion of the particular resource;
determining historical weighted values of the set of historical data points, wherein determining the weighted values comprises:
applying a first weight for the first media platform to the first quantity of impressions to generate a first weighted value;
applying a second weight for the second media platform to the second quantity of impressions to generate a second weighted value;
obtaining historical effectiveness information corresponding to the plurality of advertising campaigns;
identifying a plurality of sets of training data points using the historical weighted values of the set of the set of historical data points and historical effectiveness information;
training a machine leaning model based on the plurality of sets of training data points to compute effectiveness values for advertising campaigns;
obtaining a candidate set of data points corresponding to a plurality of candidate advertising campaigns;
computing a particular set of weighted values based on the candidate set of data points;
computing, by the machine leaning model, effectiveness values for the individual data points of the candidate set of data points based on the particular set of weighted values;
determining a maximum of the effectiveness values;
selecting a target data point of the candidate set of data points associated with the maximum of the effectiveness values;
communicating recommended divisions of a second resource for allocation among the plurality of media platforms based on the target data point associated with the maximum of the effectiveness values; and
updating the machine learning model based on feedback corresponding to the effectiveness values computed for at least one of the target set of data points.

18. The system of claim 17, wherein training the machine leaning model comprises identifying data and patterns of effectiveness of particular resource allocations at particular media platforms of the plurality of media platforms in generating platform impressions.

19. The system of claim 18, wherein the machine learning model is a random forest model.

20. The system of claim 18, wherein the sets of training data points include product segments, product types, target demographics, portions of a budget used in generating platform impressions, and actual quantities of platform impressions.

21. The system of claim 17, wherein the plurality of media platforms comprise one or more of types of media platforms, including: linear television services, connected television services, and streaming digital video services.

22. The system of claim 17, wherein the resources comprise a budget.

23. The system of claim 22, wherein the effectiveness values represent Returns-On-Investment of the budget.

24. The system of claim 23, wherein communicating recommend divisions comprises identifying percentages of the budget for allocation to the plurality of media platforms based on a first data point associated with the maximum of the effectiveness values.
